(19) United States
(12) Patent Application Publication
(10) Pub. No.: US 2018/0115965 A1
(43) Pub. Date: Apr. 26, 2018

(54) USER TERMINAL, RADIO BASE STATION, RADIO COMMUNICATION SYSTEM AND RADIO COMMUNICATION METHOD

(71) Applicant: NTT DOCOMO, INC., Tokyo (JP)

(72) Inventors: Kazuki Takeda, Tokyo (JP); Satoshi Nagata, Tokyo (JP); Jing Wang, Beijing (CN); Liu Liu, Beijing (CN); Huiling Jiang, Beijing (CN)

(73) Assignee: NTT DOCOMO, INC., Tokyo (JP)

(21) Appl. No.: 15/564,745

(22) PCT Filed: Apr. 8, 2016
(86) PCT No.: PCT/JP2016/061498

§ 371 Date: Oct. 6, 2017

(30) Foreign Application Priority Data
Apr. 9, 2015 (JP) 2015-080323

(51) Int. Cl. H04W 72/04; H04W 72/12; H04L 5/00

(52) U.S. Cl. CPC H04W 72/042; H04W 72/048; H04W 72/121; H04L 5/005; H04L 5/0016; H04L 5/0053; H04L 5/0037

(57) ABSTRACT

The present invention is designed so that, in enhanced carrier aggregation, the control information that is required in cross-carrier scheduling can be reduced. A user terminal can communicate with a radio base station by using six or more component carriers, and has a receiving section that receives a downlink control channel, which includes a group DCI (Downlink Control Information) that contains scheduling control information for a plurality of component carriers, and that is comprised of an information field that is common for a plurality of component carriers and an information field that is specific to each component carrier.

### TECHNICAL FIELD

The present invention relates to a user terminal, a radio base station, a radio communication system and a radio communication method in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). The specifications of LTE-advanced have already been drafted for the purpose of achieving further broadbandization and higher speeds beyond LTE, and, in addition, for example, successor systems of LTE—referred to as, for example, “FRA” (future radio access)—are under study.

Also, the system band of LTE Rel. 10/11 includes at least one component carrier (CC), where the LTE system band constitutes one unit. Such bundling of a plurality of CCs into a wide band is referred to as “carrier aggregation” (CA).

In LTE Rel. 12, which is a more advanced successor system of LTE, various scenarios to use a plurality of cells in different frequency bands (carriers) are under study. When the radio base stations to form a plurality of cells are substantially the same, the above-described carrier aggregation is applicable. On the other hand, when the radio base stations to form a plurality of cells are completely different, dual connectivity (DC) may be employed.

### CITATION LIST

### Non-Patent Literature

Non-Patent Literature 1: 3GPP TS 36. 300 “Evolved Universal Terrestrial Radio Access (E-UTRA) and Evolved Universal Terrestrial Radio Access Network (E-UTRAN); Overall Description; Stage 2”

### SUMMARY OF INVENTION

### Technical Problem

In the carrier aggregation of LTE Rel. 10/11/12, the number of component carriers that can be configured per user terminal is limited to maximum five. In LTE Rel. 13 and later versions, in order to achieve more flexible and faster wireless communication, and the number of component carriers that can be configured per user terminal is made six or greater, and enhanced carrier aggregation to bundle these component carriers is under study.

In existing carrier aggregation, support is provided so that one component carrier can carry out cross-carrier scheduling (CCS) with maximum five component carriers, including the subject component carrier. In enhanced carrier aggregation, there is a need to provided support so that one component carrier can carry out cross-carrier scheduling with six or more component carriers, including the subject component carrier.

In enhanced carrier aggregation, in which the number of component carriers that can be configured per user terminal is in six or more, if cross-carrier scheduling is configured in the same way as in existing carrier aggregation, PDCCHs (Physical Downlink Control Channel) or EPDCCHs (Enhanced PDCCH) might unevenly concentrate in a specific component carrier. Given that the PDCCH or the EPDCCH has limited capacity, cases might occur where DCI (Downlink Control Information) for all component carriers cannot be transmitted or where DCI for a plurality of users cannot be transmitted.

The present invention has been made in view of the above, and it is therefore an object of the present invention to provide a user terminal, a radio base station, a radio communication system and a radio communication method, whereby, in enhanced carrier aggregation, the control information that is required in cross-carrier scheduling can be reduced.

### Solution to Problem

According to the present invention, a user terminal can communicate with a radio base station by using six or more component carriers, and this user terminal has a receiving section that receives a downlink control channel, which includes a group DCI (Downlink Control Information) that contains scheduling control information for a plurality of component carriers, and that is comprised of an information field that is common for a plurality of component carriers and an information field that is specific to each component carrier.

### Advantageous Effects of Invention

According to the present invention, in enhanced carrier aggregation, the control information that is required in cross-carrier scheduling can be reduced.

### BRIEF DESCRIPTION OF DRAWINGS

FIG. 1 provide diagrams to explain cross-carrier scheduling in enhanced carrier aggregation;

FIG. 2 is a diagram to explain cross-carrier scheduling in enhanced carrier aggregation;

FIG. 3 provide diagrams to explain a new DCI format according the present embodiment;

FIG. 4 provide diagrams to explain a new DCI format according the present embodiment;

FIG. 5 provide diagrams to explain a new DCI format according the present embodiment;

FIG. 6 is a diagram to show an example of a schematic structure of a radio communication system according to the present embodiment;

FIG. 7 is a diagram to show an example of an overall structure of a radio base station according to the present embodiment;

FIG. 8 is a diagram to show an example of a functional structure of a radio base station according to the present embodiment;

FIG. 9 is a diagram to show an example of an overall structure of a user terminal according to the present embodiment; and

FIG. 10 is a diagram to show an example of a functional structure of a user terminal according to the present embodiment.

### DESCRIPTION OF EMBODIMENTS

Now, an embodiment of the present invention will be described in detail below with reference to the accompanying drawings. In LTE Rel. 13, enhanced carrier aggregation, in which no limit is placed on the number of component carriers that can be configured per user terminal, is under study. In enhanced carrier aggregation, for example, a study is in progress to bundle maximum 32 component carriers. With enhanced carrier aggregation, more flexible and faster wireless communication can be realized. In addition, by enhanced carrier aggregation, it is possible to bundle a large number of component carrier into an ultra-wide continuous band.

Existing carrier aggregation provides support so that one component carrier can carry out cross-carrier scheduling with maximum five component carriers, including the subject component carrier.

In enhanced carrier aggregation, there is a need to provided support so that one component carrier can carry out cross-carrier scheduling with maximum 32 component carriers, including the subject component carrier. Consequently, one PDCCH (Physical Downlink Control Channel) or EPDCCH (Enhanced PDCCH) need needs to support cross-carrier scheduling using more than five component carriers.

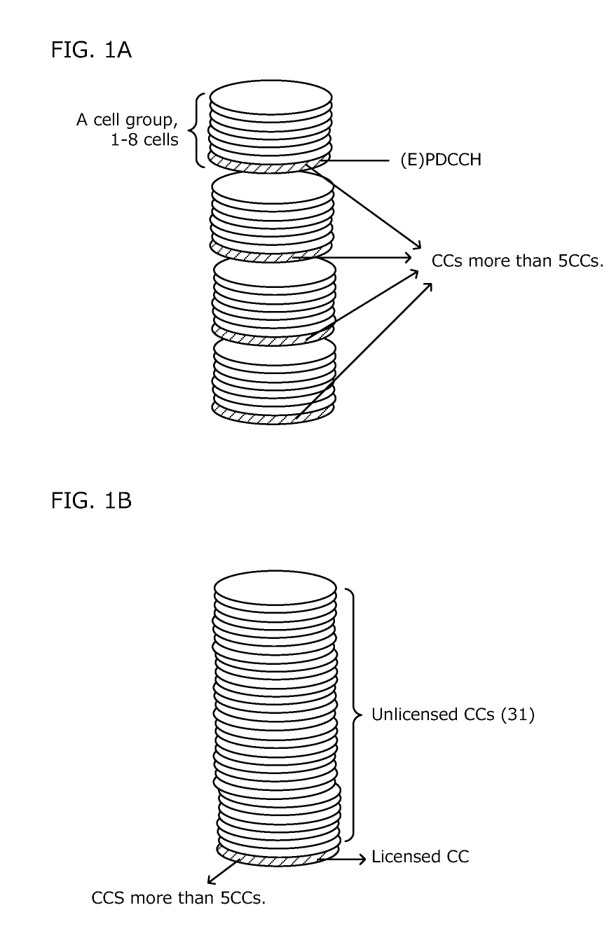

FIG. 1A shows an example, in which maximum 32 component carriers are divided into a plurality of cell groups, each comprised of one to eight component carriers, and cross-carrier scheduling is executed on a per cell group basis. One component carrier conducts cross-carrier scheduling with more than five component carriers (eight component carriers in FIG. 1A). By dividing component carriers into cell groups that are comprised of maximum eight component carriers, the existing 3-bit CIF (Carrier Indicator Field) can be used.

FIG. 1B shows an example in which one component carrier carries out cross-carrier scheduling with maximum 32 component carriers (32 component carriers in FIG. 1B). One component carrier that performs cross-carrier scheduling may be a component carrier in a licensed band, and the other 31 component carriers may be component carriers in unlicensed bands. A license band refers to a frequency band that is licensed to an operator, and an unlicensed band refers to a frequency band that does not require license.

Problems with cross-carrier scheduling in enhanced carrier aggregation include that the PDCCH or the EPDCCH has limited capacity, and that the number of times to try blind decoding of the PDCCH or the EPDCCH and the blocking rate increase.

In conventional cross-carrier scheduling, one PDCCH or EPDCCH supports cross-carrier scheduling of five component carriers. In cross-carrier scheduling in enhanced carrier aggregation, one PDCCH or EPDCCH supports cross-carrier scheduling of six or more component carriers (6 to 32 component carriers).

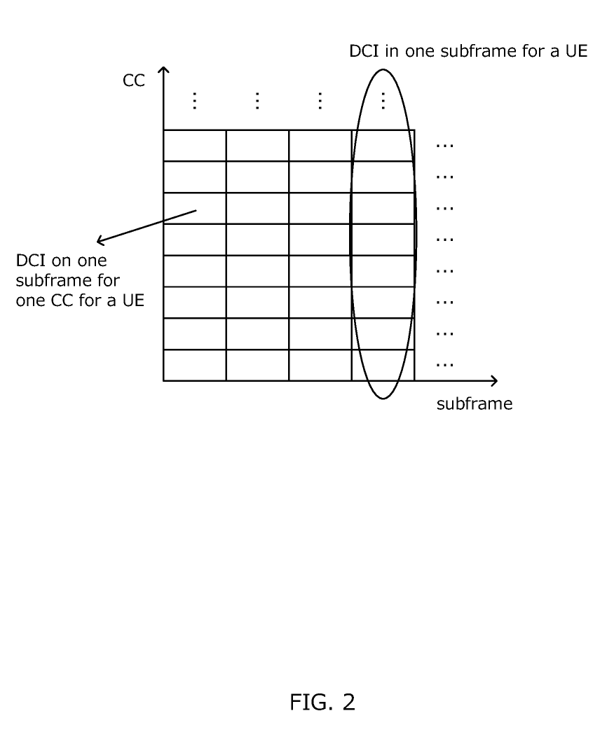

In cross-carrier scheduling, a user terminal applies blind-decoding to the PDCCH or the EPDCCH and detects DCI (Downlink Control Information), which is a control signal addressed to the subject terminal. DCI is required depending on the number of component carriers, and, for one component carrier, a DCI is transmitted from one subframe (see FIG. 2). When performing cross-carrier scheduling of 32 component carriers, 64 DCIs are needed in the uplink and the downlink. Therefore, the capacity of the PDCCH or the EPDCCH is limited as the number of component carriers that are supported for cross-carrier scheduling increases.

By this means, the present inventors have found out new a new DCI format to support cross-carrier scheduling of a plurality of component carriers. To be more specific, the present inventors have come up with the idea of reducing the control information that is required in cross-carrier scheduling by grouping DCIs for a plurality of component carriers into a single DCI. This DCI may be a control signal that is detected as one DCI by applying blind decoding to the PDCCH or the EPDCCH.

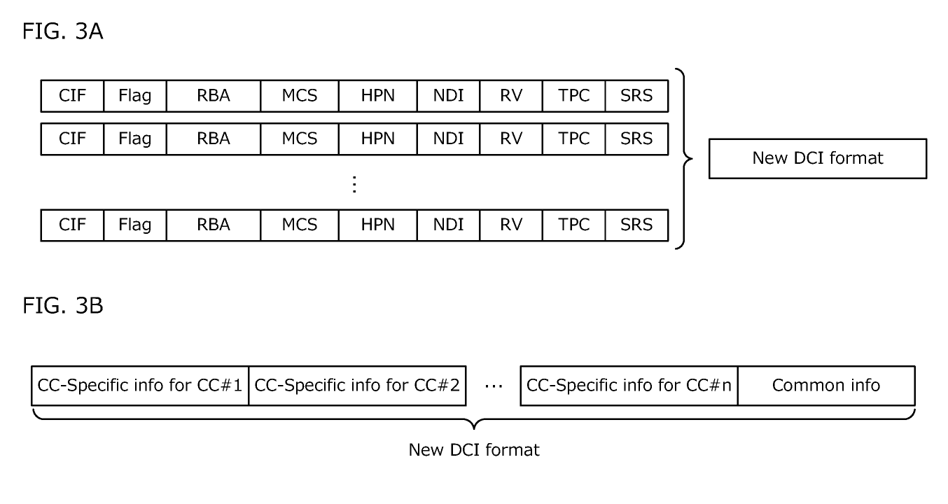

As a new DCI format, a group DCI to include scheduling control information of a plurality of component carriers is defined (see FIG. 3A). In the example shown in FIG. 3A, new DCI format is provided by grouping a plurality of DCI formats 1A. In DCI format 1A, a CIF, a flag (Flag for format differentiation), an RBA (Resource Block Assignment), an MCS (Modulation and Coding Scheme), an HPN (Hybrid Automatic Repeat Request) Process Number), an NDI (New Data Indicator), an RV (Redundancy Version), a TPC (Transmission Power Control) command, an SRS (Sounding Reference Signal) request and so on are included as control information.

Note that the DCI to group is not limited to DCI format 1A. For example, it is equally possible to use, for example, DCI format 2C, which includes scheduling information of multiple layers of component carriers targeted by DCI, or use DCI format 2D, which includes a field (antenna port(s), scrambling identity and number of layers) for notifying the scrambling sequence of the DM-RS (Demodulation Reference Signal) for data demodulation, a field (PDSCH RE Mapping and Quasi-Co-Location Indicator) for notifying the mapping pattern information of the PDSCH, and the like.

The new DCI format is comprised of an information field that is common for a plurality of component carriers, and information fields that are component carrier-specific (see FIG. 3B). The component carrier-common information field contains common scheduling control information for a plurality of component carriers. The component carrier-specific information fields contain unique scheduling control information for each component carrier.

The above HPN, NDI, RV, MCS, RBA, a TPC command (DCI format 0/4 only) for the PUSCH (Physical Uplink Shared Channel), an SRS request and so on can be include in the component carrier-specific information fields. In addition, precoding information, cyclic shift information for the DM-RS (cyclic shift for DMRS and OCC (Orthogonal Cover Codes) index) (DCI format 0/4 only), an uplink index (UL-DL configuration #0 of TDD (Time Division Duplex) only) and so on can also be included in the component carrier-specific information fields. Furthermore, information for reporting the scrambling sequence of the DM-RS for data demodulation (antenna port (s), scrambling identity and number of layers), information for reporting PDSCH mapping pattern information (PDSCH RE Mapping and Quasi-Co-Location Indicator) and so on can be included in the component carrier-specific information fields as well.

The above CIF, flag (for example, DCI format 0/1A) and TPC command for the PUCCH can include in the component carrier-common information field. In addition, an ARO (Acknowledgement Resource Offset) (EPDCCH only), a DAI (Downlink Assignment Index) (TDD only) and a CSI (Channel State Information) request and so on can be included in the component carrier-common information field.

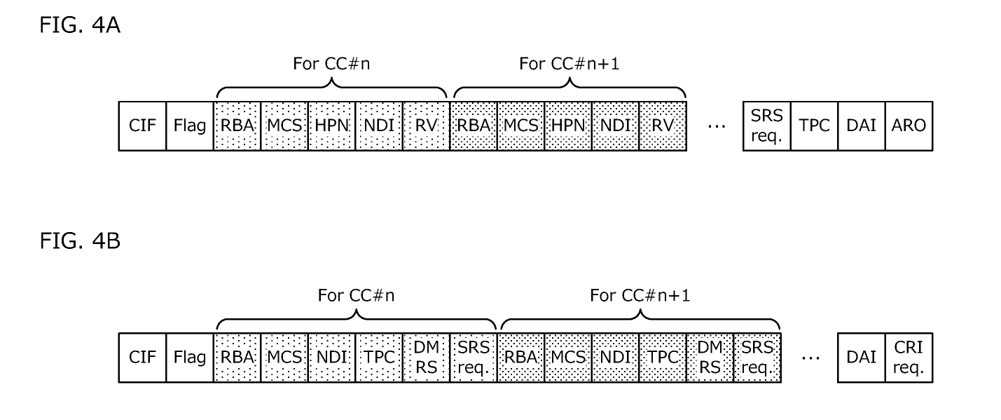

FIG. 4A shows an example of a group DCI transmitting a downlink assignment. FIG. 4B shows an example of a group DCI transmitting an uplink grant. In FIGS. 4A and 4B, the fields with a white background represent the information field common for the component carriers, and the field with a halftone background represents the information field that is unique to each component carrier.

Next, the individual fields included in the component carrier-common information field will be described.

(CIF Field)

Conventionally, when cross-carrier scheduling is applied, the indices of the cells to be scheduled are reported by using the 3-bit CIF included in each DCI.

When a group DCI is set, only one CIF field may be used irrespective of the number of component carriers, and the index of the cell group to which the group DCI is allocated may be designated by this value. For example, assuming that CCs #0 to #5 are group #1 and CCs #6 to #10 are group #2, if a group DCI is transmitted and received for each group, an indication of the group is reported in the CIF field included in each group DCI. By this means, it is not necessary to insert a CIF field for every component carrier, so that the overhead for the CIF field can be reduced when scheduling a large number of component carriers.

When a group DCI is configured, a CIF field may be used as a bit map to indicate the component carriers to be scheduled. For example, when three component carriers of CC #n to CC #(n+2) are subject to a group DCI, the user terminal decodes the group DCI, and, if the CIF=“111,” judges that the group DCI is scheduled in all the component carriers from CC #n to CC #(n+2), and, if CIF=“101,” judges that the group DCI is scheduled in the two component carriers of CC #n and CC #(n+2). By this means, it is possible to show whether or not scheduling is applied to each component carrier by using the CIF. Therefore, even when a group DCI is used, fine scheduling control becomes possible for individual component carriers included in the group. Note that the component carrier-scheduling information for a component carrier corresponding to the value of “0” in the bitmap needs not be included in the group DCI. Based on the CIF value, the user terminal judges which component carrier the component carrier-specific scheduling information that is included corresponds to. By this means, the component carrier-specific scheduling information of unscheduled component carriers is reduced, so that it is possible to further reduce the overhead.

(Flag Field)

Conventionally, since DCI format 1A and DCI format 0 carry the same payload, the user terminal identifies which format detected DCI has based on the value of the flag bit included in the DCI.

When a group DCI is configured, if the number of component carriers in which this group DCI is configured is the same between the downlink and the uplink, the user terminal may judge whether the scheduling information of all the component carriers included in the group DCI is a downlink assignment or an uplink grant, based on the flag bit value. By this means, component carrier-specific flag bits are no longer necessary, thereby reducing the overhead of the PDCCH or the EPDCCH.

Even when the group DCI is set, if the number of component carriers in which the group DCI is configured (that is, the number of component carriers included in the group DCI) is different between the downlink and the uplink (that is, when the group DCI payload is different between the downlink and the uplink), blind decoding may be performed on the group DCI of each payload, without inserting the flag bit. Thus, the flag bit is not used if the payload is different, so that the overhead can be reduced even more.

Even when a group DCI is configured, it is still possible to place a flag bit in each component carrier-specific information field. In this case, the user terminal identifies whether the DCI of a specific component carrier transmits an uplink grant or a downlink assignment from each component carrier-specific information field. As a result, since a downlink assignment and an uplink grant for different component carriers can be multiplexed on one group DCI, even when both the uplink and the downlink are scheduled, the scheduling information can be transmitted and received using one group DCI. As a result, scheduling control information can be transmitted efficiently.

(SRS Request Field)

Conventionally, the SRS request field included in the downlink assignment is interpreted as a bit that triggers SRS transmission in a PUCCH-transmitting cell, and the SRS request field included in the uplink grant is interpreted as a bit that triggers SRS transmission in a cell where the PUSCH is allocated.

When group DCIs are configured, in a group DCI in which the downlink assignment is transmitted, the SRS request field may be included in the component carrier-common information field, and, in a group DCI in which the uplink grant is transmitted, the SRS request field may be included in the component carrier-specific information field.

By this means, it is possible to reduce the overhead of the group DCIs transmitting downlink assignments. In group DCIs that transmit uplink grants, it is possible to request SRS transmission per component carrier, so that individual channel measurement control can be implemented per component carrier. Also, since there is no need to request SRS transmission to the user terminal in all component carriers where a group DCI is configured, the probability that the transmission power of the user terminal reaches the upper limit (becomes “power-limited”) can be reduced. As a result, it is possible to perform SRS-based channel quality measurements more accurately.

(TPC Command Field)

Conventionally, the TPC command field included in the downlink assignment is interpreted as a bit for controlling the PUCCH transmission power of a PUCCH-transmitting cell, and the TPC command field included in the uplink grant is interpreted as a bit for controlling the PUSCH/SRS transmission power of a cell where the PUSCH is allocated.

When group DCIs are configured, in a group DCI in which the downlink assignment is transmitted, the TPC command field may be included in the component carrier-common information field, and, in a group DCI in which the uplink grant is transmitted, t the TPC command field may be included in the component carrier-specific information field.

By this means, it is possible to reduce the overhead of the group DCIs transmitting downlink assignments. In a group DCI where the uplink grant is transmitted, the transmission power can be controlled per component carrier, so that it is possible to increase transmission power only in component carriers short of power, and to reduce transmission power in component carriers with excessive power. As a result, it is possible to reduce the number of component carriers with excessive transmission power, so that it is possible to reduce the interference power against nearby cells and improve the performance of the uplink even more.

(DAI Field)

Conventionally, in TDD, except in UL-DL configuration #0, a DAI is inserted in each downlink DCI and uplink DCI. In the event of UL-DL configuration #0, the DAI is not used, and the uplink is used instead. Note that the DAI is present only in TDD, and is not present in FDD (Frequency Division Duplex).

If a group DCI is configured, the DAI field may be included in the component carrier-common information field, and the uplink index field may be included in each component carrier-specific information field. By including the DAI field in the component carrier-common information field, the overhead can be reduced. Meanwhile, by including the uplink index field in the component carrier-specific information fields, it becomes possible schedule uplink subframes properly on a per component carrier basis.

If a group DCI is configured, the DAI field may be included in each component carrier-specific information field.

(CSI Request Field)

Conventionally, the CSI request field is a bit that is used to trigger a CSI report, and the user terminal transmits one or a plurality of CSIs in the PUSCH according to this trigger.

If a group DCI is configured, the CSI request field may be included in the component carrier-common information field. By this means, it is possible to reduce the overhead.

(Variation)

The total payload of a group DCI generally increases as the number of component carriers increases. In the situation where carrier aggregation is applied to a large number of component carriers, it is important to increase the throughput by bundling bands into a wide band and communicating at a stroke rather than performing fine scheduling control for individual component carriers. Therefore, by roughening the scheduling control, it is possible to further reduce the total payload of a group DCI.

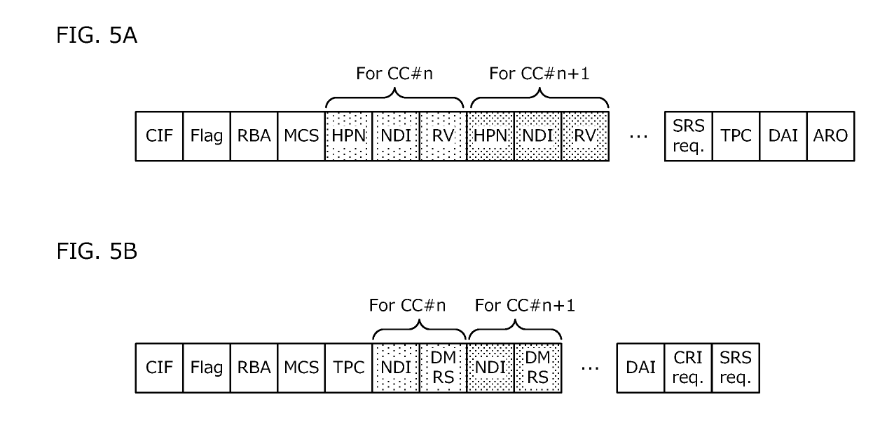

FIG. 5A shows an example of a group DCI transmitting a downlink assignment. FIG. 5B shows an example of a group DCI for transmitting the uplink grant. In FIG. 5A and FIG. 5B, the fields with a white background represent the information field that is common for the component carriers, and the field with a halftone background represents the information field that is unique to each component carrier.

In the example shown in FIG. 5, as compared with the example shown in FIG. 4, an RBA field, an MCS field, a TPC command field and an SRS request fields for the PUSCH are additionally included in the component carrier-common information field. Thus, it is possible to reduce the total payload of a group DCI.

(Control Example)

Next, a control example in the case where a new DCI format is applied will be described. Cross-carrier scheduling is configured in the user terminal by higher layer signaling. Meanwhile, the scheduling-source and scheduling-target component carriers in cross-carrier scheduling are reported to the user terminal.

The application of the new DCI format to the user terminal can be configured by higher layer signaling, or the user terminal may recognize the application of the new DCI format based on the number of component carriers or based on the serving cell index or the secondary cell index. For example, the user terminal may decide to use a group DCI in cross-carrier scheduling to exceed the predetermined number (for example, five) of component carriers. The user terminal may decide to use a group DCI when the serving cell index (ServCellIndex) or the secondary cell index (SCellIndex) is 5 or greater. That is, the user terminal can use a group DCI only for component carriers with a cell index of 5 or more, and apply existing cross-carrier scheduling to component carriers with a cell index of 4 or less.

The user terminal performs blind decoding of a group DCI sent in the PDCCH or the EPDCCH. The number of times to try blind decoding is not made proportional to the number of component carriers included in the group DCI, and, in each group DCI, the number of tries at each aggregation level is determined. When multiple group DCIs for different cell groups are configured, the number of times to try blind decoding increases in proportion to the number thereof.

The location of the search space, which is the area to try for blind decoding, may be moved for each group DCI for different cell groups. In this case, the starting location of the search space can be determined by following equation 1. n_{C1} in equation 1 is replaced by the cell group index. As a result, even when group DCIs for a plurality of different cell groups are transmitted and received in the PDCCH or the EPDCCH of a specific component carrier, it is still possible to reduce the possibility that the search spaces collide with each other between the groups and the DCIs cannot be mapped (blocked).

L{(Yₖ+m+M^{(L)}·n_{C1})mod [N_{CCE,k}/L]}+i (Equation 1)

where L is the aggregation level, Yₖ=(A·Yₖ₋₁)modD, Y₋₁=n_{RNTI}≠0, A=39827, D=65537, k=[nₛ/2], nₛ is the slot index in the radio frame, m=0, . . . , M^{(L)}−1, M^{(L)} is the number of candidate PDCCHs, n_{C1} is the CIF value, N_{CCE,k} is the total number of CCEs in the control portion in subframe k, and i=0, . . . , L−1.

(Structure of Radio Communication System)

Now, the structure of the radio communication system according to the present embodiment will be described below. In this radio communication system, a radio communication method using the above-described group DCI is applied.

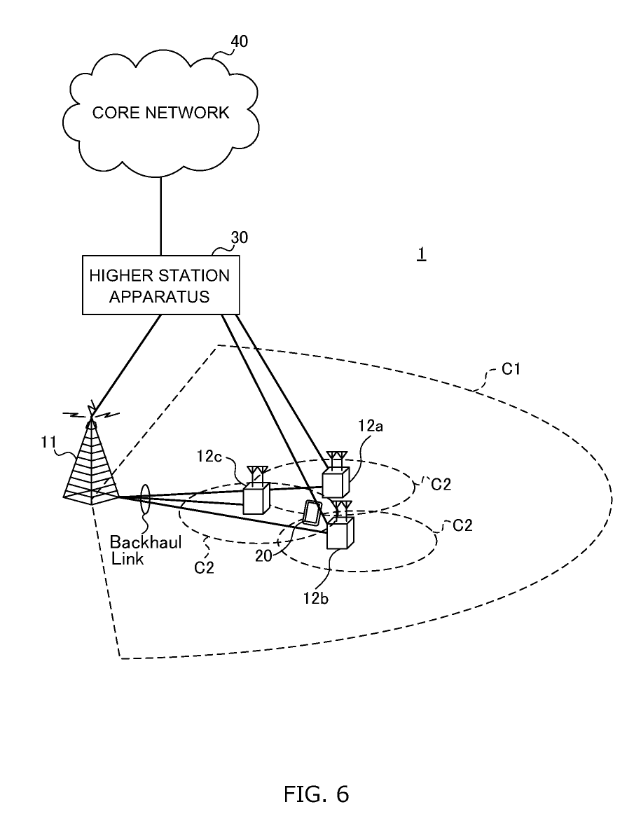

FIG. 6 is a diagram to show an example schematic structure of the radio communication system according to the present embodiment. This radio communication system can adopt one or both of carrier aggregation (CA) and dual connectivity (DC) to group a plurality of fundamental frequency blocks (component carriers) into one, where the LTE system bandwidth constitutes one unit.

As shown in FIG. 6, a radio communication system 1 is comprised of a plurality of radio base stations 10 (11 and 12), and a plurality of user terminals 20 that are present within cells formed by each radio base station 10 and that are configured to be capable of communicating with each radio base station 10. The radio base stations 10 are each connected with a higher station apparatus 30, and are connected to a core network 40 via the higher station apparatus 30.

In FIG. 6, the radio base station 11, for example, for example, a macro base station having a relatively wide coverage, and forms a macro cell C1. The radio base stations 12 are, for example, small base stations having local coverages, and form small cells C2. Note that the number of radio base stations 11 and 12 is not limited to that shown in FIG. 6.

For example, a mode may be possible in which the macro cell C1 is used in a licensed band and the small cells C2 are used in unlicensed bands. Also, a mode may be also possible in which part of the small cells C2 is used in a licensed band and the rest of the small cells C2 are used in unlicensed bands. The radio base stations 11 and 12 are connected with each other via an inter-base station interface (for example, optical fiber, the X2 interface, etc.).

The user terminals 20 can connect with both the radio base station 11 and the radio base stations 12. The user terminals 20 may use the macro cell C1 and the small cells C2, which use different frequencies, at the same time, by way of carrier aggregation or dual connectivity.

The higher station apparatus 30 may be, for example, an access gateway apparatus, a radio network controller (RNC), a mobility management entity (MME) and so on, but is by no means limited to these.

In the radio communication system 1, a downlink shared channel (PDSCH: Physical Downlink Shared CHannel), which is used by each user terminal 20 on a shared basis, a downlink control channel (PDCCH (Physical Downlink Control CHannel), EPDCCH (Enhanced Physical Downlink Control CHannel), etc.), a broadcast channel (PBCH) and so on are used as downlink channels. User data, higher layer control information and predetermined SIB s (System Information Blocks) are communicated in the PDSCH. Downlink control information (DCI) is communicated using the PDCCH and/or the EPDCCH.

Also, in the radio communication system 1, an uplink shared channel (PUSCH: Physical Uplink Shared Channel), which is used by each user terminal 20 on a shared basis, and an uplink control channel (PUCCH: Physical Uplink Control Channel) are used as uplink channels. User data and higher layer control information are communicated by the PUSCH.

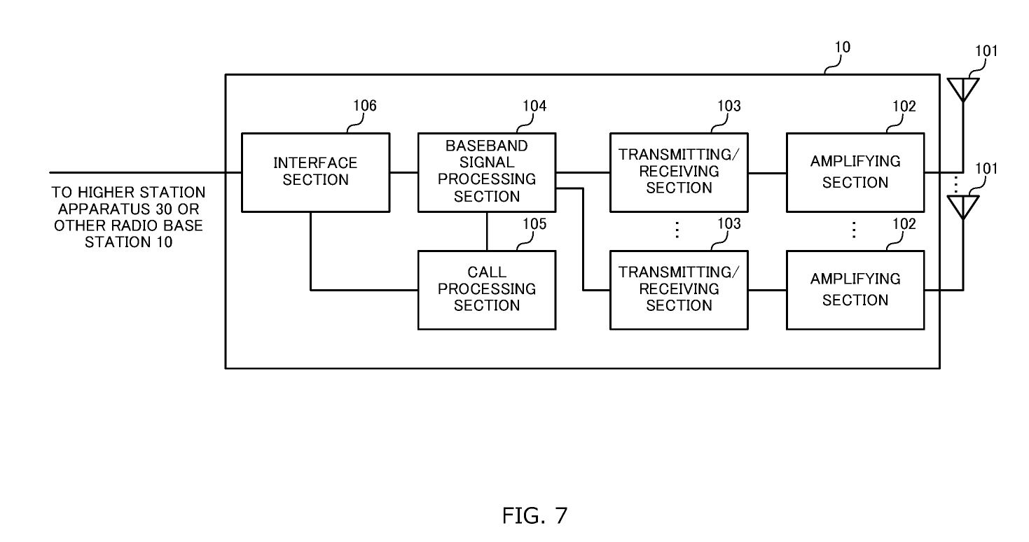

FIG. 7 is a diagram to explain an overall structure of a radio base station 10 according to the present embodiment. As shown in FIG. 7, the radio base station 10 has a plurality of transmitting/receiving antennas 101 for MIMO (Multiple Input Multiple Output) communication, amplifying sections 102, transmitting/receiving sections (transmitting sections and receiving sections) 103, a baseband signal processing section 104, a call processing section 105 and an interface section 106.

User data to be transmitted from the radio base station 10 to a user terminal 20 on the downlink is input from the higher station apparatus 30, into the baseband signal processing section 104, via the interface section 106.

In the baseband signal processing section 104, the user data is subjected to a PDCP (Packet Data Convergence Protocol) layer process, user data division and coupling, RLC (Radio Link Control) layer transmission processes such as an RLC retransmission control transmission process, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Each transmitting/receiving section 103 converts downlink signals that are pre-coded and output from the baseband signal processing section 104 on a per antenna basis, into a radio frequency bandwidth. The radio frequency signals subjected to frequency conversion in the transmitting/receiving sections 103 are amplified in the amplifying sections 102, and transmitted from the transmitting/receiving antennas 101. For the transmitting/receiving sections 103, transmitters/receivers, transmitting/receiving circuits or transmitting/receiving devices that can be described based on common understanding of the technical field to which the present invention pertains can be used.

Each transmitting/receiving section 103 transmits a downlink control channel (PDCCH or EPDCCH), which includes a group DCI that includes scheduling control information for a plurality of component carriers, and that is comprised of an information field that is common for a plurality of component carriers and information fields that are component carrier-specific.

As for uplink signals, radio frequency signals that are received in the transmitting/receiving antennas 101 are each amplified in the amplifying sections 102, converted into baseband signals through frequency conversion in each transmitting/receiving section 103, and input into the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the interface section 106. The call processing section 105 performs call processing such as setting up and releasing communication channels, manages the state of the radio base station 10 and manages the radio resources.

The interface section 106 transmits and receives signals to and from neighboring radio base stations (backhaul signaling) via an inter-base station interface (for example, optical fiber, the X2 interface, etc.). Alternatively, the interface section 106 transmits and receives signals to and from the higher station apparatus 30 via a predetermined interface.

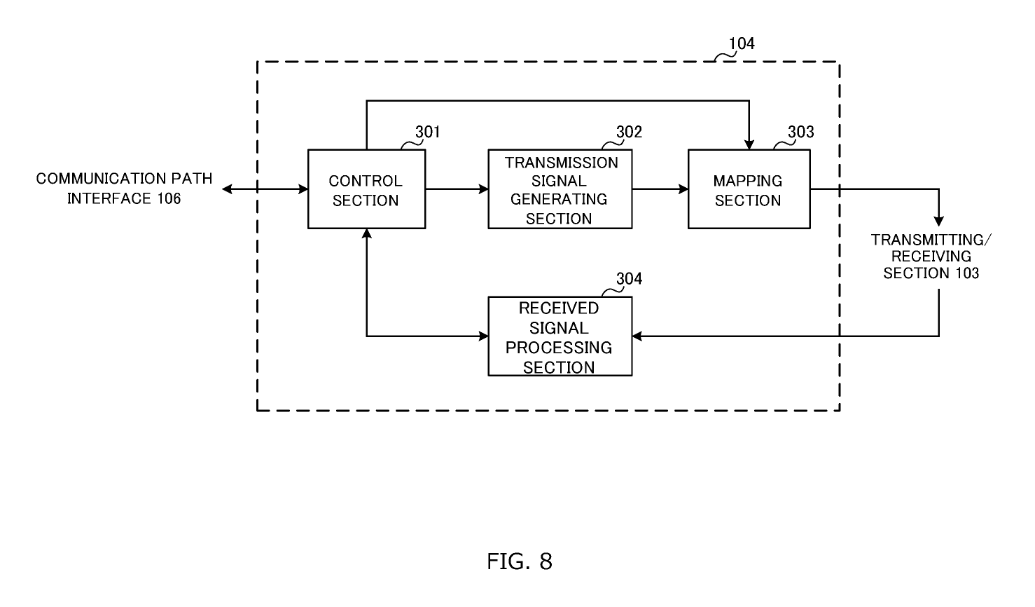

FIG. 8 is a diagram to show a principle functional structure of the baseband signal processing section 104 provided in the radio base station 10 according to the present embodiment. As shown in FIG. 8, the baseband signal processing section 104 provided in the radio base station 10 is comprised at least of a control section 301, a transmission signal generating section 302, a mapping section 303 and a received signal processing section 304.

The control section 301 controls the scheduling of downlink user data that is transmitted in the PDSCH, downlink control information that is communicated in one or both of the PDCCH and the enhanced PDCCH (EPDCCH), downlink reference signals and so on. Also, the control section 301 controls the scheduling (allocation control) of RA preambles communicated in the PRACH, uplink data that is communicated in the PUSCH, uplink control information that is communicated in the PUCCH or the PUSCH, and uplink reference signals. Information about the allocation control of uplink signals (uplink control signals, uplink user data, etc.) is reported to the user terminals 20 by using downlink control signals (DCI).

The control section 301 controls the allocation of radio resources to downlink signals and uplink signals based on command information from the higher station apparatus 30, feedback information from each user terminal 20 and so on. That is, the control section 301 functions as a scheduler. For the control section 301, a controller, a control circuit or a control device that can be described based on common understanding of the technical field to which the present invention pertains can be used.

The transmission signal generating section 302 generates downlink signals based on commands from the control section 301 and outputs these signals to the mapping section 303. For example, the downlink control signal generating section 302 generates downlink assignments, which report downlink signal allocation information, and uplink grants, which report uplink signal allocation information, based on commands from the control section 301. Also, the downlink data signals are subjected to a coding process and a modulation process, based on coding rates and modulation schemes that are selected based on channel state information (CSI) from each user terminal 20 and so on. For the transmission signal generating section 302, a signal generator or a signal generating circuit that can be described based on common understanding of the technical field to which the present invention pertains can be used.

The mapping section 303 maps the downlink signals generated in the transmission signal generating section 302 to predetermined radio resources based on commands from the control section 301, and outputs these to the transmitting/receiving sections 103. For the mapping section 303, a mapper, a mapping circuit or a mapping device that can be described based on common understanding of the technical field to which the present invention pertains can be used.

The received signal processing section 304 performs the receiving processes (for example, demapping, demodulation, decoding and so on) of the UL signals that are transmitted from the user terminals (for example, delivery acknowledgement signals (HARQ-ACKs), data signals that are transmitted in the PUSCH, random access preambles that are transmitted in the PRACH, and so on). The processing results are output to the control section 301. By using the received signals, the received signal processing section 304 may measure the received power (for example, the RSRP (Reference Signal Received Power)), the received quality (for example, the RSRQ (Reference Signal Received Quality)), channel states and so on. The measurement results may be output to the control section 301. The received signal processing section 304 can be constituted by a signal processor, a signal processing circuit or a signal processing device, and a measurer, a measurement circuit or a measurement device that can be described based on common understanding of the technical field to which the present invention pertains.

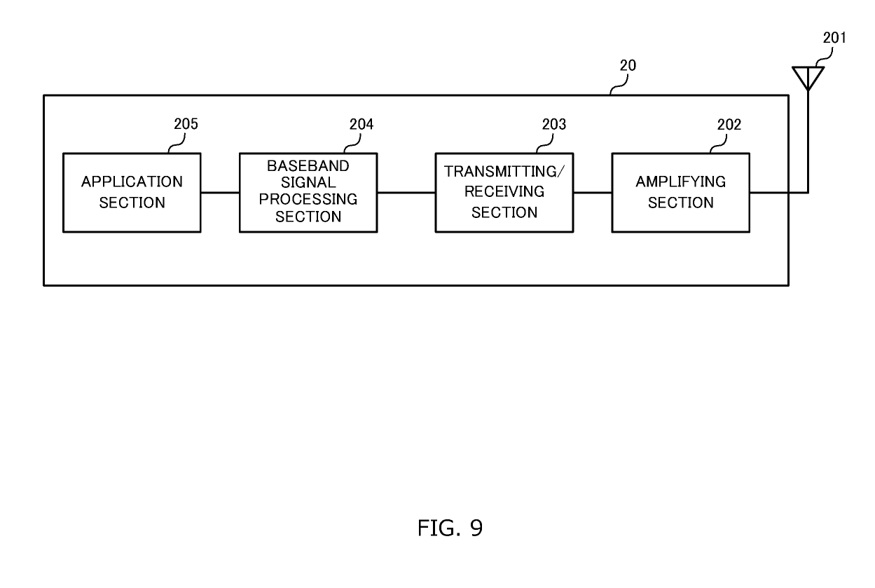

FIG. 9 is a diagram to show an overall structure of a user terminal 20 according to the present embodiment. As shown in FIG. 9, the user terminal 20 has a plurality of transmitting/receiving antennas 201 for MIMO communication, amplifying sections 202, transmitting/receiving section (transmission section and receiving section) 203, a baseband signal processing section 204 and an application section 205.

A radio frequency signal that is received the transmitting/receiving antenna 201 is amplified in the amplifying section 202 and converted into the baseband signal through frequency conversion in the transmitting/receiving section 203. This baseband signal is subjected to an FFT process, error correction decoding, a retransmission control receiving process and so on in the baseband signal processing section 204. In this downlink data, downlink user data is forwarded to the application section 205. The application section 205 performs processes related to higher layers above the physical layer and the MAC layer, and so on. Furthermore, in the downlink data, broadcast information is also forwarded to the application section 205. For the transmitting/receiving section 203, a transmitter/receiver, a transmitting/receiving circuit or a transmitting/receiving device that can be described based on common understanding of the technical field to which the present invention pertains can be used.

Uplink user data is input from the application section 205 to the baseband signal processing section 204. In the baseband signal processing section 204, a retransmission control (HARQ) transmission process, channel coding, precoding, a discrete Fourier transform (DFT) process, an inverse fast Fourier transform (IFFT) process and so on are performed, and the result is forwarded to transmitting/receiving section 203. The baseband signal that is output from the baseband signal processing section 204 is converted into a radio frequency band in the transmitting/receiving section 203. After that, the amplifying section 202 amplifies the radio frequency signal having been subjected to frequency conversion, and transmits the resulting signal from the transmitting/receiving antenna 201.

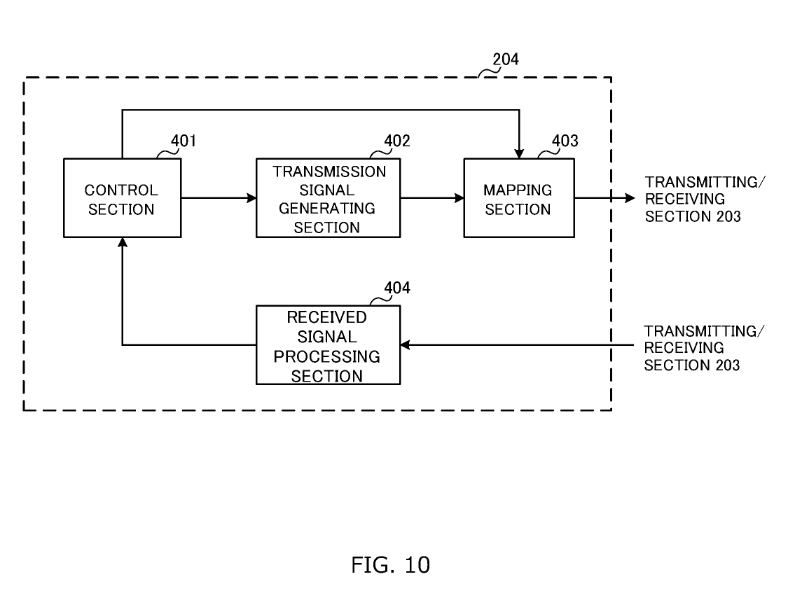

FIG. 10 is a diagram to show a principle functional structure of the baseband signal processing section 204 provided in the user terminal 20. Note that, although FIG. 10 primarily shows functional blocks that pertain to characteristic parts of the present embodiment, the user terminal 20 has other functional blocks that are necessary for radio communication as well. As shown in FIG. 10, the baseband signal processing section 204 provided in the user terminal 20 is comprised at least of a control section 401, a transmission signal generating section 402, a mapping section 403 and a received signal processing section 404.

For example, the control section 401 acquires the downlink control signals (signals transmitted in the PDCCH/EPDCCH) and downlink data signals (signals transmitted in the PDSCH) transmitted from the radio base station 10, from the received signal processing section 404. The control section 401 controls the generation of uplink control signals (for example, delivery acknowledgement signals (HARQ-ACKs) and so on) and uplink data signals based on the downlink control signals, the results of deciding whether or not retransmission control is necessary for the downlink data signals, and so on. To be more specific, the control section 401 controls the transmission signal generating section 402 and the mapping section 403.

The control section 401 performs blind decoding of the downlink control signals (downlink control channel) and detects group DCIs.

The transmission signal generating section 402 generates uplink signals based on commands from the control section 401, and outputs these signals to the mapping section 403. For example, the transmission signal generating section 402 generates uplink control signals such as delivery acknowledgement signals (HARQ-ACKs) and channel state information (CSI) based on commands from the control section 401. Also, the transmission signal generating section 402 generates uplink data signals based on commands from the control section 401. For example, when an uplink grant is included in a downlink control signal that is reported from the radio base station 10, the control section 401 commands the transmission signal generating section 402 to generate an uplink data signal. For transmission signal generating section 402, a signal generator or a signal generating circuit that can be described based on common understanding of the technical field to which the present invention pertains can be used.

The mapping section 403 maps the uplink signals generated in the transmission signal generating section 402 to radio resources based on commands from the control section 401, and output the result to the transmitting/receiving sections 203. For the mapping section 403, mapper, a mapping circuit or a mapping device that can be described based on common understanding of the technical field to which the present invention pertains can be used.

The received signal processing section 404 performs receiving processes (for example, demapping, demodulation, decoding and so on) of DL signals (for example, downlink control signals transmitted from the radio base station, downlink data signals transmitted in the PDSCH, and so on). The received signal processing section 404 outputs the information received from the radio base station 10, to the control section 401. The received signal processing section 404 outputs, for example, broadcast information, system information, paging information, RRC signaling, DCI and so on, to the control section 401.

Also, the received signal processing section 404 may measure the received power (RSRP), the received quality (RSRQ) and channel states, by using the received signals. The measurement results may be output to the control section 401.

The received signal processing section 404 can be constituted by a signal processor, a signal processing circuit or a signal processing device, and a measurer, a measurement circuit or a measurement device that can be described based on common understanding of the technical field to which the present invention pertains.

Note that the block diagrams that have been used to describe the above embodiment show blocks in function units. These functional blocks (components) may be implemented in arbitrary combinations of hardware and software. The means for implementing each functional block is not particularly limited. That is, each functional block may be implemented with one physically-integrated device, or may be implemented by connecting two or more physically-separate devices via radio or wire and using these multiple devices.

For example, part or all of the functions of radio base stations 10 and user terminals 20 may be implemented using hardware such as ASICs (Application-Specific Integrated Circuits), PLDs (Programmable Logic Devices), FPGAs (Field Programmable Gate Arrays), and so on. The radio base stations 10 and user terminals 20 may be implemented with a computer device that includes a processor (CPU), a communication interface for connecting with networks, a memory and a computer-readable storage medium that stores programs.

The processor and the memory are connected with a bus for communicating information. The computer-readable recording medium is a storage medium such as, for example, a flexible disk, an opto-magnetic disk, a ROM, an EPROM, a CD-ROM, a RAM, a hard disk and so on. Also, the programs may be transmitted from the network through, for example, electric communication channels. The radio base stations 10 and user terminals 20 may include input devices such as input keys and output devices such as displays.

The functional structures of the radio base stations 10 and user terminals 20 may be implemented by using the above-described hardware, may be implemented by using software modules to be executed on the processor, or may be implemented by combining both of these. The processor controls the whole of the user terminals by running an operating system. The processor reads programs, software modules and data from the storage medium into the memory, and executes various types of processes. These programs have only to be programs that make a computer execute each operation that has been described with the above embodiments. For example, the control section 401 of the user terminals 20 may be stored in a memory and implemented by a control program that operates on the processor, and other functional blocks may be implemented likewise.

Note that the present invention is by no means limited to the above embodiments and can be carried out with various changes. The sizes and shapes illustrated in the accompanying drawings in relationship to the above embodiment are by no means limiting, and may be changed as appropriate within the scope of optimizing the effects of the present invention. Besides, implementations with various appropriate changes may be possible without departing from the scope of the object of the present invention.

The disclosure of Japanese Patent Application No. 2015-080323, filed on Apr. 9, 2015, including the specification, drawings and abstract, is incorporated herein by reference in its entirety.

1. A user terminal that can communicate with a radio base station by using six or more component carriers, the user terminal comprising a receiving section that receives a downlink control channel, which includes a group DCI (Downlink Control Information) that contains scheduling control information for a plurality of component carriers, and that is comprised of an information field that is common for the plurality of component carriers and an information field that is specific to each component carrier.

2. The user terminal according to claim 1, wherein:
the group DCI includes a CIF (Carrier Indicator Field) field in the common information field for the plurality of component carriers; and
a value of the CIF field specifies an index of a cell group where the group DCI is allocated.

3. The user terminal according to claim 1, wherein the group DCI includes a flag field in the common information field for the plurality of component carriers; and
a value of the flag field specifies whether scheduling information of all component carriers included in the group DCI is a downlink assignment or an uplink grant.

4. The user terminal according to claim 1, wherein:
when the group DCI transmits a downlink assignment, an SRS (Sounding Reference Signal) request field is included in the common information field for the plurality of component carriers; and
when the group DCI transmits an uplink grant, the SRS request field is included in the component carrier-specific information field.

5. The user terminal according to claim 1, wherein:
when the group DCI transmits a downlink assignment, a TPC (Transmission Power Control) command field is included in the common information field for the plurality of component carriers; and
when the group DCI transmits an uplink grant, the TPC command field is included in the component carrier-specific information field.

6. The user terminal according to claim 1, wherein the group DCI includes a DAI (Downlink Assignment Index) field in the common information field for the plurality of component carriers.

7. The user terminal according to claim 1, wherein the group DCI includes a CSI (Channel State Information) request field in the common information field for the plurality of component carriers.

8. A radio base station that can communicate with a user terminal by using six or more component carriers, the radio base station comprising a transmission section that transmits a downlink control channel, which includes a group DCI (Downlink Control Information) that contains scheduling control information for the plurality of component carriers, and that is comprised of an information field that is common for a plurality of component carriers and an information field that is specific to each component carrier.

9. A radio communication system comprising a radio base station and a user terminal that communicate by using six or more component carriers, wherein:
the radio base station comprises:
a downlink control channel, which includes a group DCI (Downlink Control Information) that contains scheduling control information for a plurality of component carriers, and that is comprised of an information field that is common for the plurality of component carriers and an information field that is specific to each component carrier; and
the user terminal comprises:
a receiving section that receives the downlink control channel; and
a control section that performs blind decoding of the downlink control channel and detects the DCI.

10. The radio communication method for a user terminal that can communicate with a radio base station by using six or more component carriers, the radio communication method comprising the step of receiving a downlink control channel, which includes a group DCI (Downlink Control Information) that contains scheduling control information for the plurality of component carriers, and that is comprised of an information field that is common for a plurality of component carriers and an information field that is specific to each component carrier.
